(19) United States
(12) Patent Application Publication
(10) Pub. No.: US 2009/0280905 A1
(43) Pub. Date: Nov. 12, 2009

(54) Multiplayer handheld computer game system having tiled display and method of use

(76) Inventors: Jordan K. Weisman, Bellevue, WA (US); Jeffery M. Jones, Dearfield, IL (US)

Correspondence Address: Jordan K. Weisman, 1202 Princeton Dr, Glendale, CA, 91205, US

(21) Appl. No.: 12/152,200

(22) Filed: May 12, 2008

(51) Int. Cl. A63F 13/00

(52) U.S. Cl. 463/40

(57) ABSTRACT

A multiplayer handheld game employs individual game units having individual displays. Players can prepare their moves in secret on their game unit using controls and the individual displays, but when the game units are joined together, the game plays out on the aggregated screen. The game units employ digital signatures to ensure that all play is fair and that the virtual game pieces and characters in play have not been doctored or are otherwise fraudulent. Game results can be uploaded to a remote, secure server, which also serves as a backup for user data. Customization, improvements, and additions to the virtual game pieces and characters can be performed in conjunction with the secure server.

### FIELD OF THE INVENTION

The present invention relates generally to a multiplayer computer game system. More particularly, it relates to a system and method for tiling the displays of a plurality of game systems together during an interval of play to achieve a large screen display.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

Handheld computer games, such as the GameBoy™ and Nintendo DS™, both by Nintendo of America, Inc., of Redmond, Wash. have proven to be very popular and versatile gaming platforms. The combination of portability and computational power allows for a convenient, satisfying gaming experience.

Many such handheld game systems allow for multiplayer gaming by wired or wireless interconnection among the individual players' game units.

### Collectable Games

Certain games, for example the Pokemon™ series of adventures, also by Nintendo, encourage a player to collect a menagerie of game characters and to trade members of their collection with their friends. In general, the characters are produced by of data comprising codified capabilities, behaviors and interactions, and digital media assets (pictures, sounds, animations) that are used to simulate and represent the character. Individualization of a character by is usually achieved by interaction with the player in a game context, and in competition with other characters, including those belonging to other players.

In the arena of non-computer games, a variety of collectable games have emerged. Beginning in 1993, Magic the Gathering™, created by Richard Garfield and published by the Wizards of the Coast, of Renton, Wash., introduced the notion of game pieces, in this case cards, wherein each player had a collection, in this case a deck, likely comprising a very different mix of the available pieces. A further innovation provided by Garfield was that in the universe of pieces, certain ones were common, others rare, and some extremely rare. Other collectable games have since been developed, including miniature figures game Mage Knight™, and model ships game, Pirates of the Spanish Main™, both by WizKids, Inc. of Seattle, Wash., and have demonstrated the continued success of variable rarity play pieces.

Though characters in the Pokemon games have variable frequencies of occurrence within a game, how and when a particular character is encountered is quickly documented and published. In such products, the unfolding of the game becomes less a question of what character might be discovered and when, but rather an itinerary of activities to be performed so that an anticipated character appears.

Further, even ‘rare’ characters can be exposed and activated by video game cheat cartridges, such as those of the GameShark™ brand manufactured by Mad Catz, Inc. The GameShark products comprise a cartridge which is interposed between a game system and a compatible game cartridge. The function of the cheat cartridge is to provide a player with a means of editing data structures or the software itself in the system RAM, such that features or characters can be enabled or enhanced without the burden of achieving the access or enhancement through the intended in-game activities and mechanisms. Among the cheats possible is often an ability to make a character invulnerable or infinitely strong, or other conditions that might be impossible to achieve in standard play.

Cheat cartridges are a special, mass-market implementation of tools common for development and testing of computer hardware and software, of which some examples include in-circuit emulators, in-circuit debuggers, JTAG (Joint Test Action Group) test access ports, and other debug ports. Such tools permit a competent user to freeze an operating program, analyze the code, and modify data. Tools such as those described above could have been used by a manufacturer of a cheat cartridge to determine what cheats were easily available, such as those merely requiring data values to be changed, and to design more complex ones, such as those requiring code edits or bypasses.

With such capabilities, it is difficult to prevent a sufficiently sophisticated user from extracting a game's secrets and replicating data structures otherwise representative of rare pieces or characters within the game. As soon as there is sufficient rarity of a game piece, there is sufficient motivation for someone to expend the effort to duplicate that game piece.

As a result of this significant disadvantage, there are a lack of games for handheld consoles that incorporate variable-rarity for game pieces or characters, since such cheating devices or more sophisticated tools stand ready to make rare characters easily obtainable and inexpensive.

### Multiplayer Environments and Screen Size

A persistent issue with handheld and other game systems is how to achieve more elaborate and more compelling graphical presentations with which to wow the players and their friends, which in turn can drive system and game sales.

In handheld games, this issue is particularly acute due to the small size and low resolution, compared to playing games with HDTVs or personal computer monitors as displays). The small size and lower resolution is a challenge.

This issue is exacerbated in multiplayer games, where the play pieces of more than one player need to be shown. In most games, the multiplayer situation is handled with multiple viewpoints: Each player's in-game viewpoint is drawn on that player's screen. This commonly results in each system drawing the same objects on each player's screen, but usually from a different viewpoint corresponding to each player.

If a bird's-eye or map view of the whole action is the mode of display, this display is replicated on each player's display. This can represent a waste of display capacity when both players are near and the game does not require secrecy.

However, many games DO require secrecy as a player is preparing for the next move or round of a game. This need for secret preparation is at odds with the desirability of sharing displays for improved graphical presentation.

To clarify terminology, references to characters or game pieces and the like of the present invention should be considered references to virtual embodiments, that is, the data representative of an instance of a character or a game piece. For a player to ‘have a character’ in the present invention means that the player, in the data comprising his state in a game program, has data representative of his possession of that character. As an example from the prior art, if a particular character were built into each game cartridge, but the character was not enabled in the game until a certain in-game event had take place (e.g., a successful search of a region). Once the in-game criteria for obtaining the character have been met, then there would be a flag in the game state indicating that the character is available to the player. Alternatively, a record containing at least part of the data representing the character may have been created. Such a data record may be created by copying from a template applicable to that character, or with an algorithm (such as using random numbers to generate the character's stats). This point is made to minimize confusion between similar uses of such phrases with respect to non-computer-base games.

### Summary of Needs Unsatisfied by Prior Art

Thus, prior game systems have failed to meet a number of needs.

There is a need for a system having improved cheat resistance, in which the in-game effort needed to enhance a character or game piece cannot be bypassed such that the enhancement is achievable without the in-game effort.

There remains a further need for a system in which game pieces or characters which are intended to be rare cannot be replicated or prematurely enabled by cheat cartridges, or with standard software and hardware development tools.

Given a cheat resistant game system, there is a need for a video game having an number of characters or play pieces of which some characters or play pieces are less common than others to the point of some characters or play pieces being extremely rare.

There is a need for a means of trading characters and play pieces among players so that rare pieces find their elevated value in a virtual economy, but without exposing the characters or pieces to copying or modification.

There is a need for a combined, shared view of game play, such that smaller screens are integrated into an effective larger display.

In many racing and sports games, the dynamics and aesthetics of televised event coverage is simulated by switching between virtual cameras following one or more virtual points of interest, for instance the leader of the race, or a player traveling particularly fast. It would be desirable if such ‘cameraship’ coverage was possible during play or during a playback of the game on a combined screen, such that panoramas larger than those achievable on individual displays could be achieved.

The present invention satisfies these and other needs and provides further related advantages.

### OBJECTS AND SUMMARY OF THE INVENTION

The object of the present invention is to prevent duplication of virtual objects such as characters, points, or game pieces other than through those methods intended for the game.

It is a further object of the present invention to prevent enhancement or modification of virtual objects other than through those methods intended for the game.

It is a still further object of the present invention to prevent the transfer of virtual objects from one game system to another, other than through secure methods intended by the game designer.

It is a correlated object of the present invention to maintain, in the universe of virtual objects for a game, that virtual objects intended to be rare, remain rare; and that virtual objects intended to be unique remain unique.

It is an object of the present invention to allow the individual screen of a player's game system to be combined with the displays of additional game systems to produce a larger effective screen.

It is an further object of the present invention to allow, in a multiplayer game, screens of the individual players' game systems to be combined into a larger effective screen shared by the players, whether during play or during a replay of the game.

It is an object of the present invention to allow the larger, combined screen to be broken down into individual screens, for more convenient handling and use or for secret activity during appropriate phases of a game.

These and other features and advantages of the invention will be more readily apparent upon reading the following description of a preferred exemplified embodiment of the invention and upon reference to the accompanying drawings.

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a block diagram of the present invention showing a game system having a connection to a server;

FIG. 2 shows three game systems of the present invention connected to form a combined, panoramic screen;

FIG. 3 is a detailed block diagram of a game system of the present invention;

FIG. 4 shows a process for initializing a game system of the present invention;

FIG. 5 shows a process for loading assets into a game system of the present invention.

FIG. 6 shows a process for registering a game system to a user or a user's account;

FIG. 7 shows process for a ‘factory reset’ of the game system, suitable for recovering from otherwise fatal errors;

FIG. 8 shows a process for an asset sync, whereby the state of a game system is restored or transferred to a new game system;

FIG. 9 shows a flowchart for a plurality of game systems to be combined, determine their own configuration, and utilize the combined display;

FIG. 10 depicts the transfer of a data record for initiating a game sequence while the game systems are combined;

FIG. 11 depicts the exchange of data records needed to execute a step in a game sequence while the game systems are combined; and,

FIG. 12 shows a process for each player to upload a log obtained from an individual or shared game sequence to the server.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

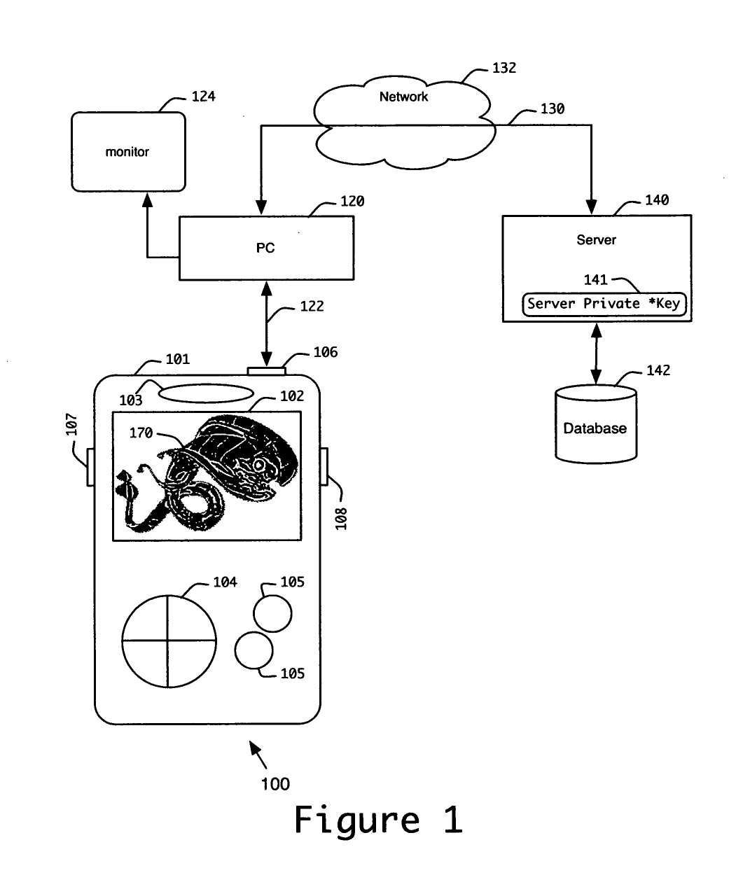

The preferred embodiment of this invention centers on portable game system 100, shown in FIG. 1. Portable game system 100 is comprised of a sturdy handheld case 101, an individual display screen 102, speaker 103 or headphone jack (not shown), directional joypad 104, control buttons 105, upload port 106, and left- and right-side communication ports 107 and 108, respectively. Other controls, for instance keyboards, analog joysticks, analog throttles, or touchpads (none shown) also may be supplied.

Game data is preferably uploaded from or downloaded to game system 100 though upload port 106. The data is transferred through data path 122, which is preferably a ‘sneaker-net’ path, but may be an electrical, optical, wireless path, preferably to personal computer 120. Over connection 130, personal computer 120 has access through the Internet 132 to server 140.

In the preferred implementation, the ‘sneaker-net’ version, data path 122 is formed by transferring a USB memory stick (not shown) from upload port 106 comprising a USB port to another USB port (not shown) on personal computer 120. In such a configuration, the data being transferred in either direction is preferably stored on the memory stick as one or more files.

In another implementation, data path 122 is formed by a USB cable running from upload port 106 and a mating USB port (not shown) on personal computer 120.

In still another embodiment, data path 122 is wireless and upload port 106 may comprise an optical communication port, or an RF communication transceiver, for example a Bluetooth module.

Server 140 refers to database 142 to support transactions such as ones that create, restore, update, distribute, or transfer game records for game system 100.

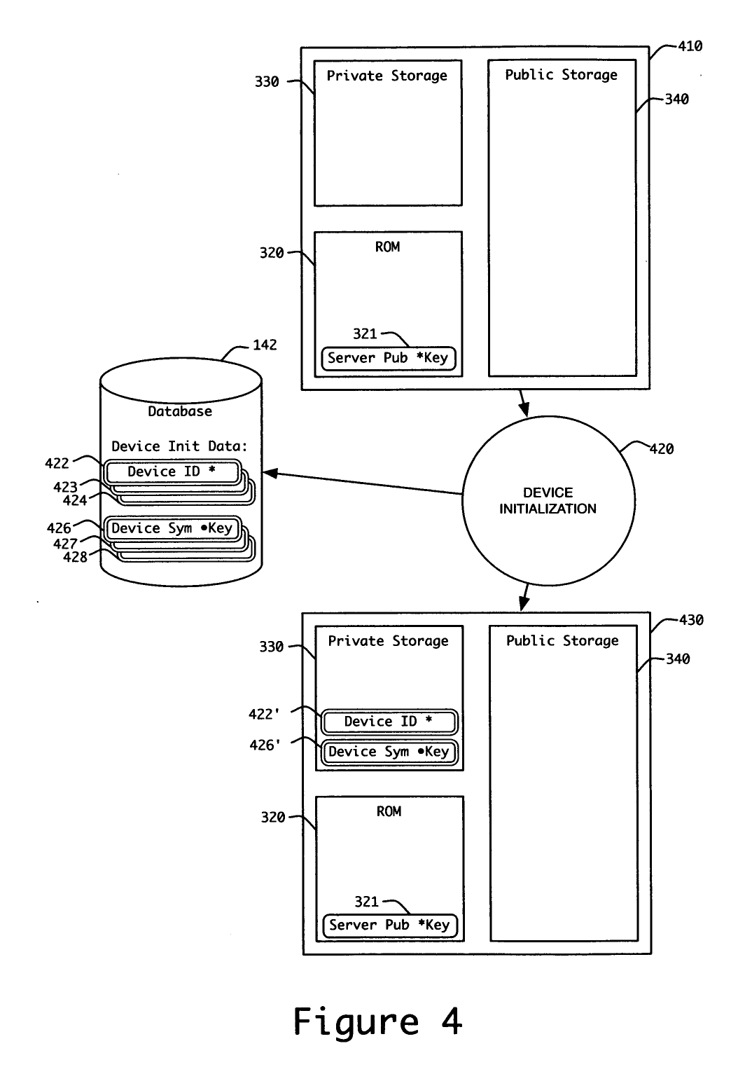

Server 140 also has a private key 141 for use in cryptography, to support sending and receipt of encrypted messages and providing digital signatures for the purpose of authenticating files and records. This, and the meaning of the asterisk (‘*’) shown in private key 141, will be discussed further in conjunction with FIGS. 4 through 12.

As needed, personal computer 120 can provide a user interface with a dedicated application (not shown) or with a web browser application (not shown) accessing server 140, with the user interface being displayed on monitor 124. User interface for supporting transactions are well-known in the art and need not be described here.

In an alternative embodiment, the connection between game unit 100 and server 140 can be made without personal computer 120. For instance, upload port 106 can comprise an Ethernet interface and form connection 130 through the Internet 132 directly. Note that in FIG. 1, the details of a connection from computer 120 to the WAN (Internet 132) are not shown, but are well-known in many variations. In still another embodiment, the connection between game unit 100 and server 140 can be wireless, as with WiFi or with data connections provided through the cellular telephone network.

In an exemplary game, a virtual character 170 is displayed on screen 102 of game unit 100. Accompanying the image or animation shown on screen 102 are preferably sounds of character 170, emitting from speaker 103. Such presentations, too, are well known in the art.

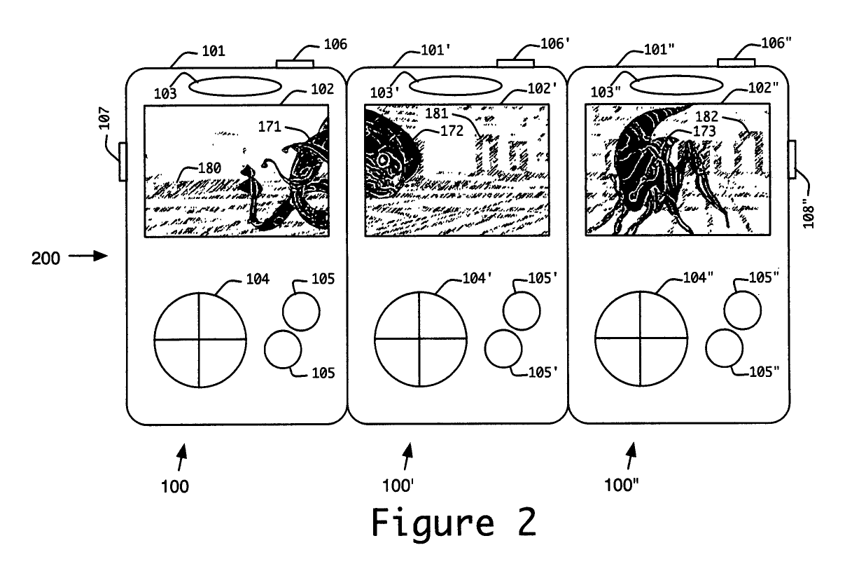

Referring now to FIG. 2, game units 100, 100′, and 100″ have been connected together, side-by-side to form game unit array 200. Each game unit 100, 100′, 100″ has corresponding screens 102, 102′, 102″; speakers 103, 103′, 103″; joypads 104, 104′, 104″; buttons 105, 105′, 105″; ports 106, 106′, 106″.

The unoccupied left-side communication port 107 of unit 100 is seen, as is the unoccupied right-side communication port 108″ of unit 100″. However, the previously shown right-side communication port 108 of unit 100 is joined to the mating left-side port of unit 100′, neither of which is seen in FIG. 2 because units 100 and 100′ are pressed closely and obscure the view of them. Similarly, the right-side communication port of unit 100′ is joined to the mating left-side communication port of unit 100″ and the view of both is obscured by the close joining of the units 100′ and 100″.

In this configuration, a communication path is formed that interconnects units 100, 100′, and 100″ of array 200, wherein unit 100 has direct communication with unit 100′, but indirect communication with unit 100″ through unit 100′. Unit 100′ has direct communication with both units 100 and 100″. This communication path enables the creation of an effective larger screen comprising displays 102, 102′, and 102″, in this case to display a contiguous, panoramic view of a game environment, comprising background landscape 180, 181, and 182 and game objects. In this example, left-side 171 of character 170 is seen on display 102, while right-side 172 of character 170 is seen on display 102′. A second character 173, likely owned by one of the players owning units 100′ or 100″, is shown.

One expects that a titanic battle is about to ensue. And rather than each player seeing the battle unfold on their respective, single small screens (e.g., 102 or 102″), the clash is going to occur on a much larger, wide-screen, panoramic display that results from the combination of screens 102, 102′, and 102″.

Note that while in the preferred embodiment, game systems 100, 100′, and 100″ are described as hand-held. However, similar principles can be applied to alternative embodiments, such as laptop computers used for game play, or for gaming consoles that might each drive a corresponding external monitor. In such cases, the configuration of the individual displays may not be implied by the specific interconnection of the units by the communication ports such as 107 and 108. In such case, a manual process may be employed to identify the relative position of each screen to the corresponding computers. Manual configuration of screen-placement is well-known in the art, as with the Macintosh and Windows operating systems (by Apple, Inc. of Cuppertino, Calif., and Microsoft Corporation, of Redmond, Wash. respectively), though such configuration is applied to single computers driving multiple screens, rather than application to a plurality of computers having individual screens.

In another alternative embodiment, communication between game units 100, 100′, and 100″ may be achieved wirelessly, for example using optical or RF communication interfaces, such as those described above. In an embodiment using RF interfaces, communication ports such as 107 and 108 are preferably replaced by interlocking clips, magnetic couplers, alignment pins, or the like, to hold the game units in substantial alignment, but this is not strictly required.

In the preferred embodiment, array 200 comprises two or more connected units 100, 100′, and 100″ shown in FIG. 2 to form a single row. However, in alternative embodiments, other configurations of array 200 are possible. For instance, four game units might be arranged in a square. Further, there is no requirement for the displays to be arranged in a regular pattern, for instance, three units might be arranged in a ‘L’ configuration, which would be useful to depict an assault from the base of a cliff face. In such not-purely-linear configurations, additional or differently placed communication ports like 107 and 108 would be needed. In still another embodiment, the communication among game units can be more flexible, and a manual configuration process, as above.

In still another embodiment, instead of communication ports 107 and 108, game unit 100 conveys its own identity and orientation through emitters located along its sides. Compatible receivers correspondingly located would be able to detect the emitters of another game unit, and note its identity and relative position and orientation. Such emitter/receivers might be infrared, or magnetic. Communication among game units so equipped may be implemented using a different mechanism, for example using Zigbee or Bluetooth RF connections.

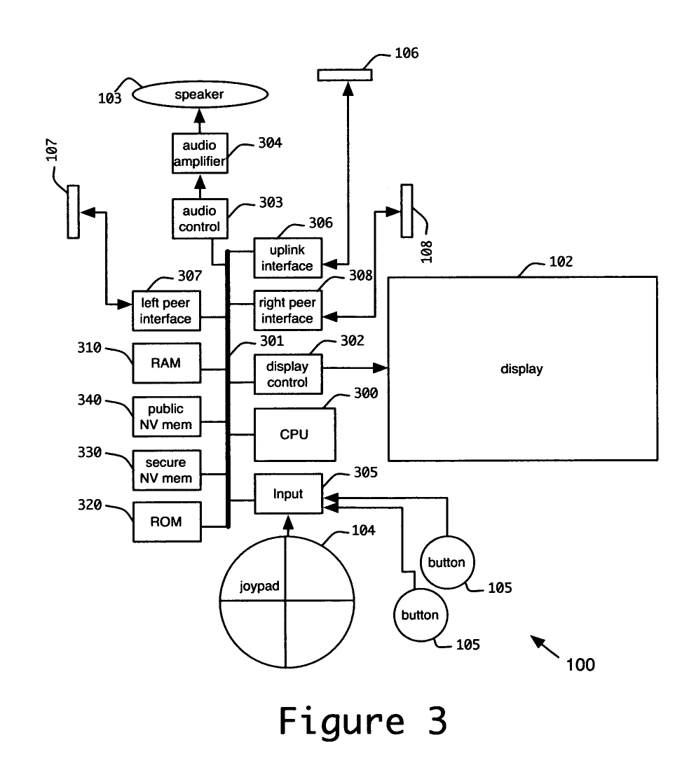

Referring now to FIG. 3, a block diagram of a exemplary handheld game unit 100 of the present invention is shown. CPU 300 connects through at least one bus 301 to various memory, I/O, and communication subsystems. Display 102 is driven by display control 302 under the control of CPU 300. Speaker 103 is driven by amplifier 304 with signals from audio control 303. User inputs from joypad 104 and buttons 105 are conditioned and made available to CPU 300 through input interface 305. Input interface 305 may also provide for additional input devices, such as keyboards, analog joysticks, analog throttles, or touchpads (none shown).

CPU 300 is also preferably provided with several classes of memory. ROM 320 is well suited to storing permanent software codes, such as a BIOS, and permanent data, as will be described in more detail below. Secure non-volatile memory 330 is configured to be written to and read only by CPU 300 and should not be available through a debug procedure or external inspection. Secure NV memory 330 will contain primarily data, but may contain code. Public non-volatile memory 340 is not required to provide the same degree of protection to its contents, which may be data or code. RAM 310 is not considered secure.

Uplink interface 306, which is preferably a USB interface, provides the connection between uplink port 106 and either non-secure internal memory (e.g., RAM 310 or public NV memory 340) or CPU 300 through bus 301.

Left peer interface 307 provides the connection to left-side port 107 while right peer interface 308 provides the connection to right-side port 108. Both left- and right-peer interface 307 and 308 connect to either non-secure internal memory, or CPU 300, through bus 301.

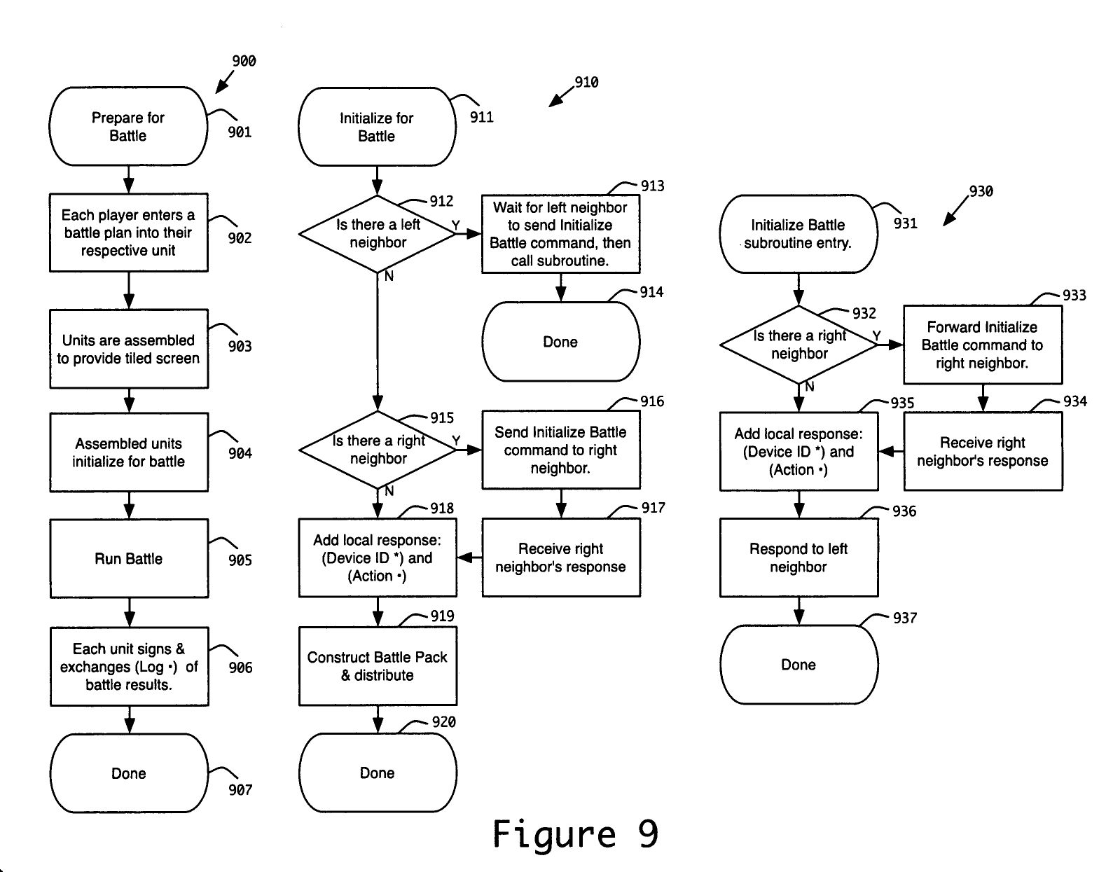

The left- and right-peer interfaces 307 and 308 can be implemented as individual Serial Peripheral Interface (SPI) devices, for example with the left-peer interface 307 configured as a slave and the right-peer interface 308 to be configured as a master. In such a configuration, leftmost game unit 100 in array 200 will not detect a slave enable on left-peer interface 307, and thereby be aware of its position as the leftmost unit in array 200. Similarly, rightmost game unit 100″ in array 200 will not find a connection (i.e., will see no returning data from a slave) on the right-peer interface corresponding to right-side port 108 and will thereby be aware of its position as the rightmost unit in array 200. However, the right-peer interface 108 of unit 100 will assert a slave enable for the left-peer interface corresponding to the left-side port (neither shown) of middle game unit 100′ of array 200, and the right-peer interface corresponding to the right-side port (neither shown) of middle game unit 100′ of array 200 will assert a slave enable for the left-peer interface corresponding to the left-side port (neither shown) of rightmost game unit 100″ and will receive return data from the left-side port of game unit 100″. In this way, game unit 100′ will be aware of its interior position in array 200, though in this embodiment, its actual position is not known except through the preparation process discussed in conjunction with FIG. 9.

In an alternative embodiment, a single SPI interface can service both left-side and right-side ports 107 and 108 in a daisy-chain configuration with a loopback circuit activated on open left-side and right-side ports. In such a configuration, the leftmost unit 100 of array 200 can detect its position by the active loopback circuit (not shown) on left-side port 107, and rightmost unit 100″ of array 200 can detect its position by the active loopback circuit (not shown) on right-side port 108″.

Any of interfaces 302, 303, 306, 307, 308 can access non-secure memories such as 310 and 340 using a direct memory access (DMA) control, or can be fed data by CPU 300. A memory management unit (not shown) may be used to control a memory cache, or to offload block copies of memory under direction of CPU 300.

Preferably, at least a portion of ROM 320 and all of secure NV memory 330 are fabricated as a part of an integrated chip comprising CPU 300. In this way, there is no opportunity for probing of any data stored in secure memory.

One preferred implementation of CPU 300 is the GPL16230A as specified by Generalplus Technology, Inc., of Taiwan, Republic of China. This system-on-a-chip (SOC) product is well-suited for an implementation of the present invention, as it comprises not only CPU 300, display control 302, audio control 303, controllers for various NV memory types suitable for implementing secure NV memory 330 and public NV memory 340, and at least a portion of ROM 320 and RAM 310, and other ancillary components such as a real-time clock, timers, etc. This chip also provides an SPI master/slave port which can be configured as one of left-side interface 307 or right-side interface 308, or can be configured as the driver for a daisy-chain configuration (not shown) as described in the alternative embodiment above.

However, in this implementation, as with many SOC implementations, secure NV memory 330 is exposed on one or more chips not fabricated on the same chip as CPU 300. Further, this CPU has built-in debug capabilities. Appropriate care must be taken that the portion of bus 301 that carries signals to and from secure NV memory 330 is resists exposure to mechanisms that will permit tampering or inspection of data stored there. One means of providing this protection is by epoxy coating the chips and circuit board to render access to the data nearly impossible. In particular, access to the native debug modes of the chip must be prevented.

In an alternative embodiment, data stored in ‘secure’ memory may instead be encrypted such that a key known to the CPU 300 is used to decrypted the information strictly inside of registers of CPU 300. If updated by CPU 300, the data is re-encrypted before being stored back into the ‘secure’ memory. In this embodiment, it doesn't matter that the encrypted data is accessible, since it can't be read so long as the keys are not accessible other than at the factory or within CPU 300.

At the time of manufacture, game unit 100 may be represented by new memory map 410. In such a memory map, the contents of mask ROM 320 includes at least some code (not shown), and a copy of the public key 321 corresponding to the private key 141 in server 140.

With private key 141, server 140 is able to generate encrypted messages or signatures that can be verified as authentically originating from server 140 or a trusted proxy (not shown) that also has access to the private key 141. The RSA encryption method taught by Rivest et al. in U.S. Pat. No. 4,405,829, can be used to create public key 321 and corresponding private key 141 and encrypted messages and digital signatures that use them.

The private key 141 in FIG. 1 and public key 321 in FIG. 4 are both shown with an asterisk (‘*’). Throughout FIGS. 4 through 12, messages or files authenticated by encryption or signature made with private key 141 and therefore decryptable or verifiable with public key 321 are also marked with an asterisk.

Public key 321 is present at the time of manufacture of device 100 because it is embedded in the semiconductor maskwork for the mask ROM 320. Among the code also contained in ROM 320 should be routines for decrypting messages or files and verifying signatures purported to be from server 140, or routines for encrypting messages or files for private transmission to server 140, and these routines are preferably the only code that accesses public key 321.

Device initialization procedure 420 is performed by server 140, or a proxy (not shown) having access to the private key 141 of server 140. Device initialization procedure 420 preferably generates a unique device ID and an associated device key, which are stored in database 142 as device ID record 422, authenticated by digital signature by private key 141, and an associated device key record 426 (the association is not shown).

A plurality of associated pairs of device ID records 422, 423, and 424 and device key records 426, 427, and 428 corresponding to a like plurality of game units (not shown) are retained by server 140 in database 142.

Also during device initialization process 420, device ID record copy 422′ and device key record copy 426′ are recorded, preferably permanently, to produce initialized memory map 430 in private storage 330 of exactly one game unit 100.

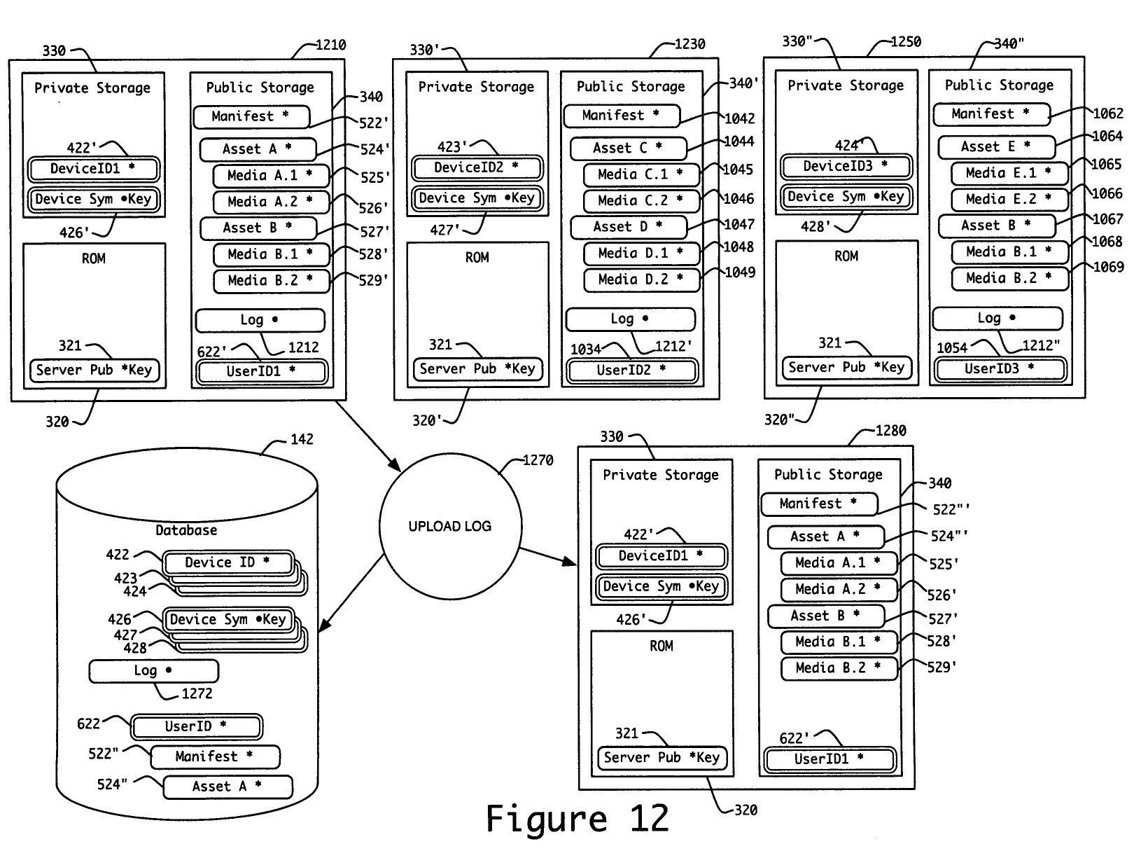

Device key record and copy 426 and 426′ are marked with a bullet (‘.’) as are messages or records encrypted or signed by the corresponding key, as seen in FIG. 12.

Device initialization process 420 ensures that there is only one game unit 100 corresponding to unique device ID record 422.

Records which have a one-to-one associate with a specific game unit 100, such as device ID record and copy 422 and 422′ and device key record and copy 426 and 426′, are drawn with a double outline in the FIGS. 4 through 8 and 10 through 12 to point out their uniqueness. Any records and files that may be legitimately duplicated among game units 100, 100′, and 100″, are shown with a single stroke border, as with server public key record 321.

Now, game unit 100 can generate a message whose author is the device ID of record 422′ and sign or encrypt that message with the device key of record 426′. Upon receipt by server 140, the database 142 can be queried to find the record 422 having the matching device ID and the associated device key record 426 can be retrieve and used to decrypt or authenticate the message. The routines to perform these message or signature preparations are also preferably stored in ROM 320.

In the preferred embodiment just described, the key in device key record 426 is a symmetric key, as these are generally less computationally intensive than asymmetric key algorithms, such as the RSA algorithm. Those skilled in the art will recognize that a public-key/private-key algorithm would work in this context, too.

The device key in device key record 426 is not necessarily unique to the device (though being unique would be a good thing), but the universe of device keys should be large, and individual keys unlikely to be repeated, to make guessing the device key difficult. In practice, the device key of records 426 and 426′ likely are unique.

In an alternative embodiment, the signature by server 140 of device ID record 422 is not required, except to allow a device to verify the integrity of private memory 330, or for use in processes described below.

In an alternative implementation of device implementation process 420, the device ID records 422, 423, and 424 and device key records 426, 427, and 428 may be generated in advance and associated before, as, or once copies, such as 422′ and 426′, are written to a device 100.

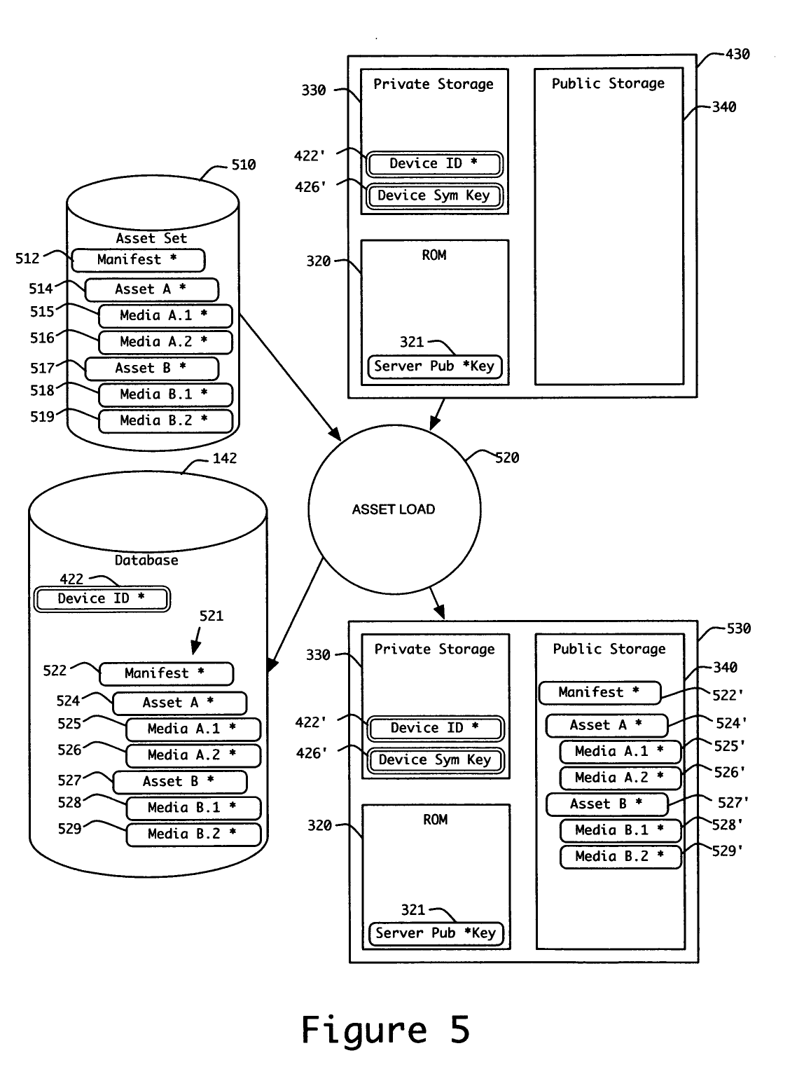

FIG. 5 shows asset load process 520 which takes an initialized memory map 430 and produces asseted memory map 530 by copying the contents of asset set 510 into public memory space 340. Asset set 510 is representative of characters, items, game pieces (such as character 170), or even environments (such as that which produced background landscapes 180, 181, and 182) which are held by game unit 100 but which may not be held by all other game units. Asset set 510 contains a manifest 512 which lists the other files and records that comprise asset set 510. Asset record 514 preferably describes the name (e.g., “Sky Viper”), type of asset (e.g., “monster”), attributes (e.g., movement=“fly,crawl”, attack=“bite”, special=“venom”) and stats (e.g., strength=“low”, “speed=“fast”) that are used to drive behaviors and interactions in the game. Media files 515 and 516 represent one or more files that contains images, sounds, 3D models, textures, motion profiles, animations, sufficient for the presentation of character 170 throughout the game, both in solo play mode as in FIG. 1, and combined play (as in FIG. 2). Preferably, individual asset files such as 515 and 516 contain media assets that are closely related and would be used together, for instance, a single media file 515 might represent the 3D model and textures necessary to render character 170, whereas media file 516 might represent a motion sequence of the model to illustrate a biting attack. The accompanying soundtrack might be included in media file 516, or be in a separate media file (not shown). Asset file 517 may include data describing an environment, such as the one illustrated as the background landscape 180, 181, and 182 in the panorama shown in FIG. 2. The description in asset file 517 can include the name (e.g., “Microcircuit Plains”, type of asset (e.g., “environment”), attributes (e.g., weather=“hot,windy”, terrain=“flat,smooth”, special=“none”). Media asset file 518 may contain background images such as were used to draw landscapes 180, 181, and 182, and media asset file 519 the ambient soundtrack for the environment.

In an alternative embodiment, instead of containing media assets suitable for 3D rendering, asset files 515 and 516 would contain 2D animations of the character.

Media files and the hierarchy they populate for each asset (515, 517) are well-known in the fields of video games and simulation modeling. Those skilled in the art will recognize that for a single character, many, perhaps even hundreds of media assets, or more, are needed to completely represent a character, and that the hierarchy used to render a view on display 102 may comprise a complex scene graph. Alternatively, the scene may be simply composed of background images and a number of animated sprites. While 2D rendering techniques can make the asset set 510 simpler, the principles the media asset storage are the same.

One significant addition to asset set 510 over the usual media asset sets in games is that each of the records and files in asset set 510 are preferably digitally signed with the private key 141 of server 140 so that their authenticity is unquestioned. This is of value if other units 100′ and 100″ when connected in array 200 require elements of asset set 510 to render their portion of the panorama. A digital signature of by server 140 authenticates the stats and attributes of asset record 514. This is discussed further below.

Preferably, a copy of the contents of asset set 510 are recorded in database 142 as being associated with device ID record 422 as device contents list 521.

Copies 522′, 524′, 525′, 526′, 527′, 528′, and 529′ of the records and files of asset set 510 and/or device contents list 521 are transferred to game unit 100 and stored in public memory 340. The record made in database 142 associating device ID record 422 with contents list 521 is valuable in case a subsequent restoration is needed (discussed below).

A further utility of asset load process 520 is for it to operate with respect to a device having previous asseted memory map to install an additional asset set. In this use of the process 520, the resulting manifest in device contents list 521 associated with the device ID 422 in database 142 and copied into public memory 340 would have the union of the previously loaded assets and those in the additional asset set. Thus, the asset load process can implement an electronic version of “booster packs”, well-known in non-electronic collectable games.

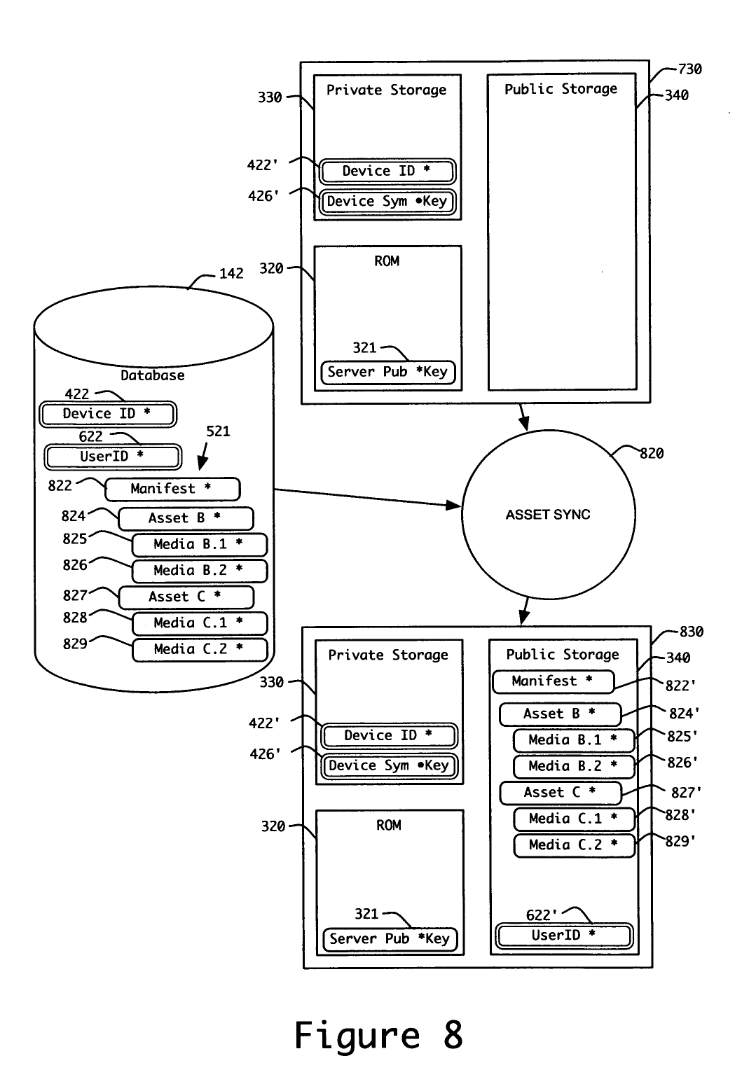

Preferably, server 140 can offer such booster packs to players through a web site accessed with personal computer 120 and shown on monitor 124. Following the selection of one or more booster packs by a player using this web site, server 140 would add the selected booster pack(s) contents to the device content list 521 in database 142 by updating the manifest, and adding the new asset records and media asset files. At the same time, the new assets can be transferred to the device through connection 130 and data path 122, or the transfer can wait for a later asset sync process 820 (described in detail below in conjunction with FIG. 8).

Preferably, if more than one instance of an asset record is present in a manifest in asseted memory map 530, the media asset files corresponding to the asset record are not duplicated. Further, within database 142, it would not be necessary to have more than one instance of any media asset file: Instances of media asset files throughout database 142 in device content lists 521 and in asset sets 510, are preferably merely references to a master instance of the media asset files.

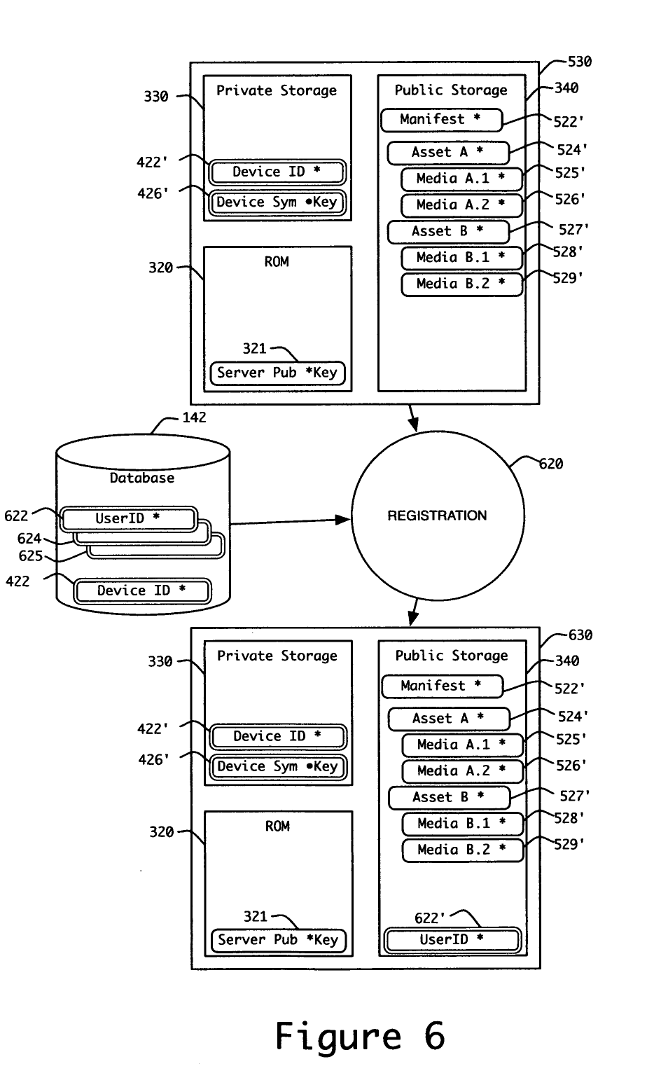

In FIG. 6, registration process 620 takes asseted memory map 530 and produces registered memory map 630 by copying authenticated user ID record 622 from database 142 as user ID record copy 622′ in public memory 340. User ID record 622 is the primary record of a player's account on server 140. During registration process, user ID record 622 would be associated in database 142 with device ID record 422 in a one-to-many relationship, that is, the owner of the account identified by user ID record 622 may own zero, one, or more game units, each having a unique device ID record, e.g., 422. But each device ID would be associated with, at most, one user ID.

Accounts on web sites as might be hosted on server 140 are well-known, and are commonly used to conduct transactions, and to participate in online communities. The database 142 used to drive such a site commonly tracks information about each user in account records. So far, an account referenced by user ID record 622 can be associated with a game unit uniquely identified by device ID record 422, which carries the collection of assets listed in asset set 510.

Note that registration process 620 and asset load process 520 could occur in any order and produce the same result. An initial asset load process 520 preferably occurs during manufacture and packaging of the game unit 100, but in the alternative may occur after the player has acquired game unit 100. In the latter case, asset load process occurs through data path 122 and connection 130 with server 140, as described above.

Registration process 620 would typically occur after the player has acquired game unit 100, and would occur with a connection to server 140 preferably through connection 130 and data path 122.

As an implementation choice, the registration process 620 can be carried out by software running on personal computer 120 with access to device ID record 422′ through data path 122, or by software running on CPU 300 having communication (however convoluted) with server 140, or a combination thereof. A similar choice may be made with respect to the implementation of asset load process 520 and other processes discussed below. However, in one alternative embodiment, a registration code (not shown) or serial number (not shown), for example printed on the outside of game unit 100 could be typed into a web-based transaction form from server 140 using personal computer 120 if the registration code or serial number was previously associated in database 142 with device ID record 422.

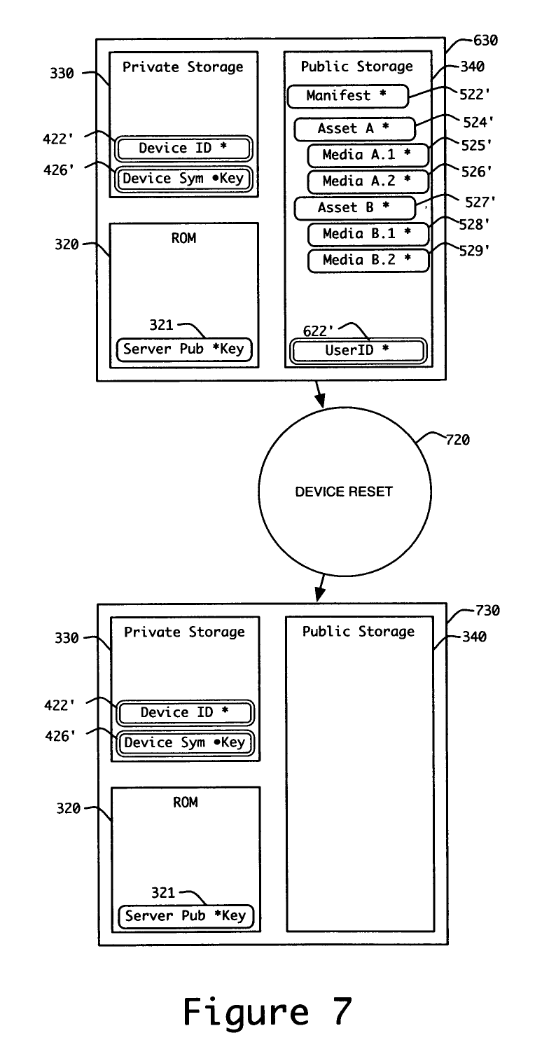

In an extreme case of abject software lockup or data corruption, as might occur if power were to fail as an NV memory was being written, it may be necessary to reset the memories of game unit 100 to a “factory default” from which game unit 100 can be restored. FIG. 7 shows the result of device reset process 720, whereby any potentially corrupt data in public memory 340 is cleared, as seen in factory reset memory map 730, which is substantially identical to initialized memory map 340. Preferably, only device ID record copy 422′ and device key record copy 426′ have been retained. User ID record copy 622′ and any asset or media files 522′, etc. have been expunged. So long as private memory 330 and ROM 320 are immune to corruption after leaving the factory, device reset process 720 will be able to recover from failures due to corrupted data.

FIG. 8 shows the asset sync process 820 which transforms a game unit 100 having any memory map configuration that is at least initialized, in this case a factory reset memory map 730, into a valid, asseted memory map 830, by searching database 142 for device ID record 422 that matches device ID record copy 422′ from private memory 330, and through the associations (not shown) in database 142, recalling and copying user ID record 622 and the records and files of asset set 510 to public memory 340, such that record copies 622′, 822′, 824′, 825′, 826′, 827′, 828′, and 829′ are restored. As described above in conjunction with prior processes, asset sync 820 is preferably conducted through data path 122 using personal computer 120 and connection 130 to server 140. The software performing asset sync 820 may be executed substantially in personal computer 120, or CPU 300, or both. Server 140 will provide the necessary search and access to database 142.

Asset sync process 820 may also be used to recover when a game unit is lost or physically damaged. By allowing the records associated with the lost or damaged unit associated with a user ID to become associated with another, potentially new, game unit also associated with the same user ID, a complete recovery of the lost or damaged unit can be achieved.

FIG. 9 anticipates two or more players having game units with asseted memory maps, that is, units 100, 100′, and 100″, each with assets representing one or more characters available to, in this example, compete in a battle.

Battle process 900 is the exemplary process for using the separate and combined capabilities of game units of the present invention. In initial step 901, players have powered up their separate, respective game units 100, 100′, and 100″ and made a selection within their individual games to perform a grouped activity, in this case, a battle.

In planning step 902, each player uses their corresponding separate machine to select a character with which to battle. The player using game unit 100 chooses character 170. The player using game unit 100″ chooses character 173. Each player uses a user interface (not shown, but known in the prior art) to select a strategy, such as preferred attacks for their selected characters. The fact that this is occurring on separate game units allows this planning step to be performed in secret. The individual strategies are recorded in each game unit in corresponding RAM 310.

In assembly step 903, the players plug the participating game units 100, 100′, and 100″ together, to form array 200, as shown in FIG. 2.

In array initialization step 904, the CPU 300 of each participating game unit executes master process 910. At the start of master process 910, in master initialization step 911, left-peer interface 307 and right-peer interface 308 are reset and readied.

In left test step 912, each game unit tests left-peer interface 307 (e.g., by examining the slave enable line) to determine whether a left neighbor is present. If so, then the current unit is not the master (the master is further to the left), and the process continues by waiting for an initialize battle command in step 913.

If, however, in left test step 912 no left neighbor is detected, then the game unit is considered to be the master and processing continues at right test step 915.

Right test step 915 examines the right-peer interface to determine if a right-side neighbor is present (e.g., by testing for incoming data when the slave enable is asserted and the serial clock is cycled for at least a byte).

If no right neighbor is detected, processing continues with add ID step 918, wherein the current game unit's device ID and action (as selected by the corresponding player during planning step 902) are added to an otherwise empty list (not shown). The device ID can include the signature of private key 141 from server 140, while the action may be signed with the corresponding device key 426′. (In an alternative embodiment, having no right neighbor at this point may be handled as a special case, because the game unit has just detected that it is the only unit in array 200.) If in right test step 915 a right neighbor is detected, processing continues with step 916.

In inquire rightward step 916, the game unit to the right of the current one is requested to execute the initialize battle command, for which it should be waiting.

Jumping now into the context of the rightward neighbor waiting in step 913 for an initialize battle command, the command has just been received from the leftward neighbor.

In response, from within step 913, initialize battle subroutine 930 is called and entered at step 931. In right test step 932, this unit tests for a right neighbor. If a right neighbor is detected (as above), then in forward command step 933, the initialize battle command is passed on to the game unit to the right. Eventually, the unit to the right returns a response that is received in step 934.

Add ID step 935 begins with the list of device IDs and actions is returned from step 934, or if no right neighbor was detected in step 932, then step 935 begins with an empty list. Local response step 935 adds to the list it received (whether or not empty) the current game unit's device ID and the action selected by its corresponding player from step 902.

At this point, the current game unit can count the entries in the list of device IDs and determine where it is within array 200. A count of one, indicating that only its own device ID is in the list, indicates that the current game unit is the rightmost one. A count of two would place it second from the right, and so one. This positional count will be used later to determine what portion of the panorama the current game unit is responsible for drawing.

Having accumulated all the device IDs and action from this game unit and all game units to the right, the list is returned to the left neighbor game unit in response step 936.

Initialize battle subroutine 930 returns at step 937, which allows the current processor to conclude step 913 from which it was called. This game unit returns from master process 910 at step 914.

Meanwhile, the leftmost game unit 100 of array 200 has just received a response from game unit 100′ of array 200, in step 917. Game unit 100 adds to that response its own device ID and action from step 902 in add ID step 918.

At this point, a list of device IDs and actions from each game unit in array 200 is known to game unit 100. In a manner similar to that in step 935, a count of device IDs will indicate the size and position of the master game unit in array 200. The master game unit already knew that it was leftmost, but it did not know the size of the array until now. In the example of FIG. 2, master game unit 100 would determine that it was in the third position, counting from the right, and that the array was three game units or three screens wide.

In battle pack distribution step 919, this list is assembled, preferably with a random number seed appended, into a message that is sent to each other game units 100′ and 100″ of array 200, wherein each game unit 100, 100′, and 100″ has the same information about the battle that is to begin now.

The leftmost, master game unit 100 completes master process 910 at step 920, and returns.

At this point, each game unit has returned from array initialization step 904 and knows whether or not it is the master, where it resides within array 200, and it has received the battle pack as distributed by the master in step 919, so it also knows the array size and the actions corresponding to each game unit in array 200.

Run battle step 905 is step that loops internally. On each iteration, each CPU 300 corresponding to the game units of array 200 computes the next iteration outcome. Since each CPU has identical information about the selected actions and is using a shared random number seed, their independently obtained results are identical. Each CPU can determine which media assets it needs to provide to its corresponding display control 302 or audio control 303 to produce the game units' next contribution to the panorama or soundtrack. These media assets can be sent or fetched (since all game units can know the others' needs), if they have not already been transferred in prior iterations or immediately following battle pack distribution step 919.

Given that it has the appropriate media files and the commonly computed iteration outcome, each game unit can ready an update for its corresponding portion of the panorama on corresponding display 102, 102′, or 102″. If necessary, the master game unit can produce a sync message so that all displays update at the same time.

If desired, player input can be accepted from controls 104 and 105 on each participating game unit. In this embodiment, the master game unit would initiate an exchange process similar to collecting the list of device IDs, to collect the control inputs from each of the game units, which would then be distributed for use in the next iteration. In this way, each iteration is computed by each game unit with identical data so that every unit's computed outcome is in sync, and identical.

In each iteration, each game unit will produce identical computations for damage, exertion, points won, and the like.

In accordance with predetermined game rules, eventually the battle comes to an end and each of the game units simultaneously exit run battle step 905.

During the iterations of battle step 905, each game unit accumulated an identical log of events. After the battle, in step 906, each game unit can summarize the event log and sign the results. The log signatures can be exchanged, which results in every game unit having an identical copy of the game log, along with a signature of the log from each participating game unit.

In a special application of battle process 900, a player may select a training activity in step 902. Step 903 may be skipped, unless the solo player has multiple game units available to enhance the display while training. In step 904, the array initializes, but will often consist of only a single game unit 100. The training can loop in run battle step 905, and training results are accumulated as a battle log. In step 906, the game unit signs the log. In this case, the log is data representative of the training activities for one or more characters. Through a log upload 1220 (discussed in conjunction with FIG. 12) and a subsequent asset sync 820, the training results represented in log records may be integrated into the authenticated asset records.

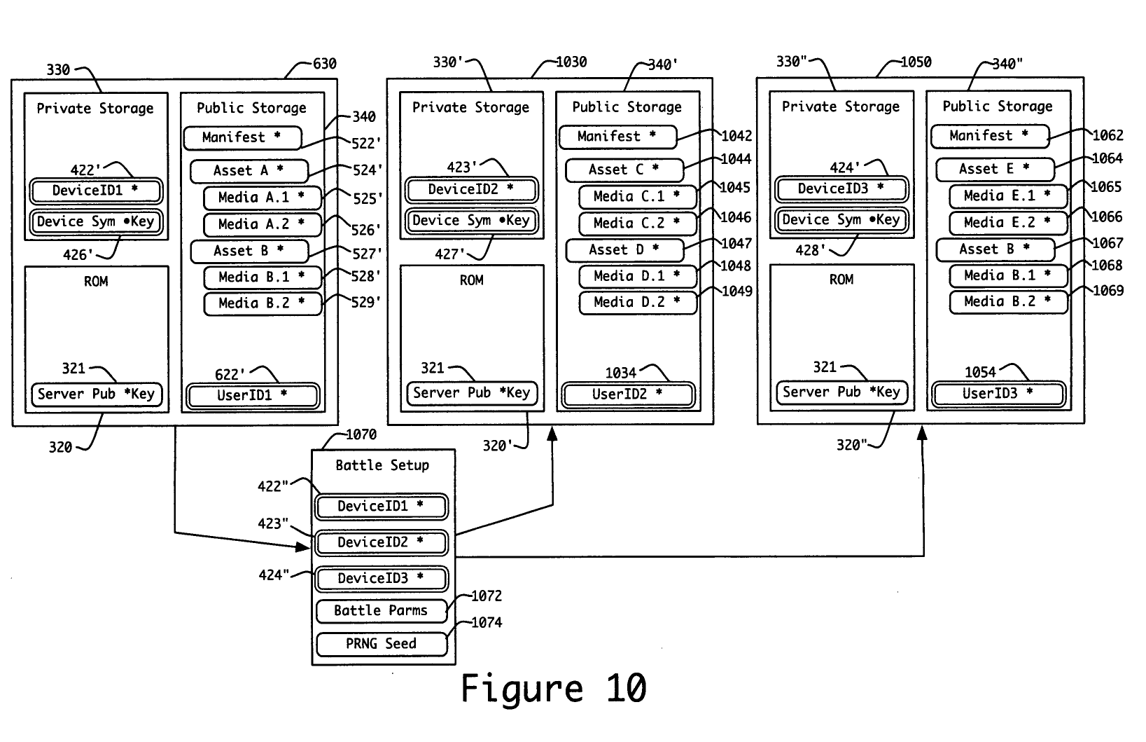

In FIG. 10, asseted memory maps 630, 1030, and 1050 are shown, corresponding to game units 100, 100′, and 100″ in FIG. 2.

Game unit 100, in its asseted memory map 630 has its device ID record copy 422′, game unit 100′ in its map 1030 has device ID record copy 423′, while game unit 100″ has device ID record copy 424′ stored in its memory map 1050.

As in memory map 630 for game unit 100, each of the other game units 100′ and 100″ have corresponding memory maps 1030 and 1050 that contain device key record copies 427′ and 428′, user ID record copies 1034 and 1054, and their own asset sets in public storage 340′ and 340″. In public memory 340′, game unit 100′ contains its manifest 1042, asset records 1044 and 1047, and media assets 1045, 1046, 1048, and 1049. In public memory 340″, game unit 100″ contains its manifest 1062, asset records 1064 and 1067, and media assets 1065, 1066, 1068, and 1069.

Note that the asset record 527′ and media assets files 528′ and 529′ in memory map 630 are the same as asset record 1067 and media asset files 1068 and 1069 of memory map 1050. This is because, though the mix of characters and objects carried by each game unit may be a custom mix, the individual characters may be duplicated, in which case the asset record and files corresponding to one non-unique character may also be possessed by another player having the same character.

If training and battle results in logs are integrated into asset records, as described above, then asset record 527′ and asset record 1067 may soon diverge, as one character will likely have different training or different battle histories than the other. However, so long as the media asset files remain pertinent (e.g., the character doesn't grow fangs, change color, or otherwise metamorphose), then the media asset files 528′ and 529′ may remain constant and identical to media asset files 1069 and 1068.

FIG. 10 also shows the battle pack message 1070 constructed by the master game unit 100 in step 919 and distributed to the other game units 100′ and 100″. Battle pack message 1070 contains device IDs 422″, 423″, and 424″ (which technically, are device ID record copy copies), and battle parameters 1072 and pseudo-random number generator (PRNG) seed 1074. Battle parameters 1072 comprises player plans captured in step 902 and collected through steps 935 and 918, which are preferably signed by the corresponding device key 436′, 427′, and 428′ for later verification by server 140 with the corresponding keys in database 142. This ensures that ultimately no credit will accrue if a fraudulent battle pack 1070 is distributed which falsifies any players' plans. Preferably, the log resulting in step 906 comprises the data represented in battle pack 1070.

Server-signed manifest record 522′ enumerates which asset are possessed by game unit 100. Preferably, manifest record 522′ also comprises device ID 1, as reported in device ID record copies 422′ and 422″. The manifest record 522′ can also be included in battle parameters 1072, to allow the other game units to verify that game unit 100 is competing with legitimately obtained characters or other virtual objects.

It will be apparent to those skilled in the art that, even if the private storage 330 and ROM 320 of game unit 100 were to be compromised, that one would still be unable to create a fraudulent battle pack 1070 that misrepresented the attributes of characters, which characters were available for play, or what each player had entered as his plans. Further, an attempt to falsify log results would require the compromise of all the participating game units, or collusion of all the players, since each game unit independently calculates the battle outcome and produces a signature of its own derived log results.

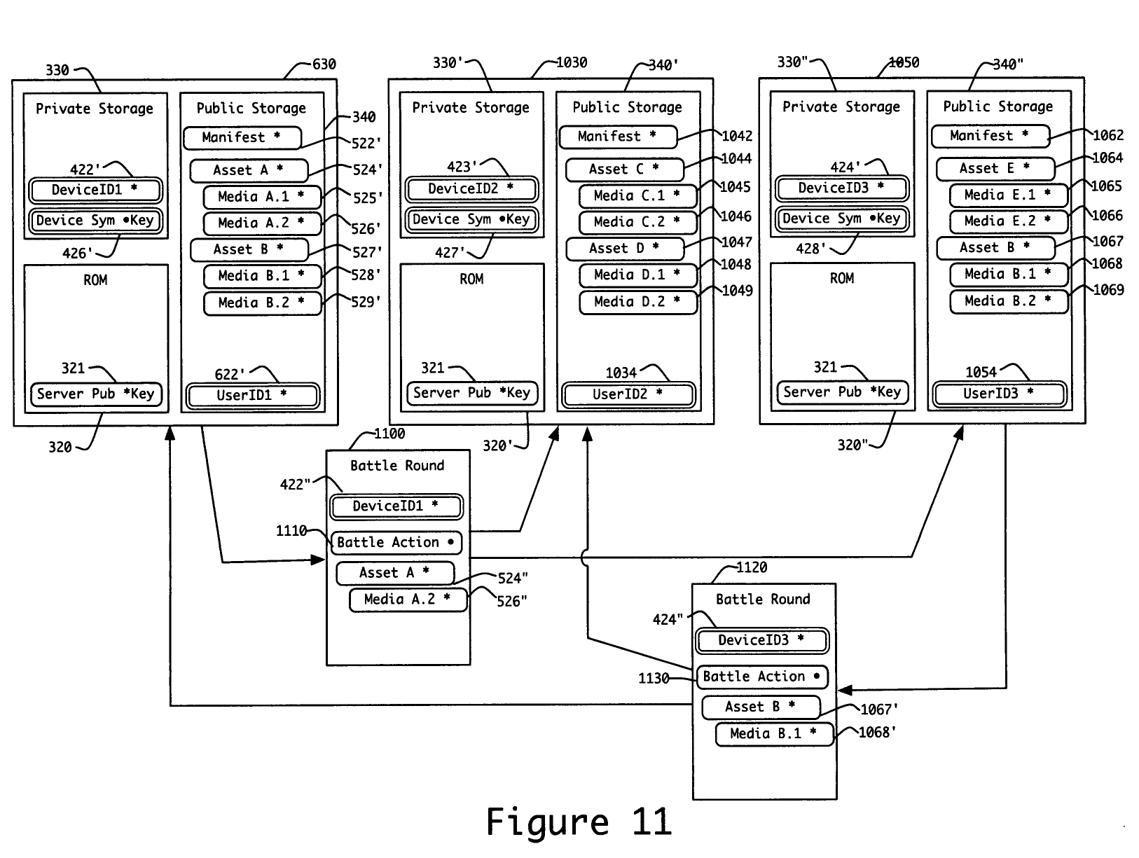

During each iteration of run battle step 905, as shown in FIG. 11, battle round messages 1100 and 1120 may be exchanged among game units 100, 100′, and 100″ (represented here by the corresponding in-battle memory maps 630, 1030, and 1050). Battle round messages 1100 and 1120 preferably contain (all respectively) a record of the sender's device ID 422″ and 1054′, signed battle action record 1110 and 1130, and asset records 524″ and 1067′ and media asset files 526″ and 1068′, as needed.

If game unit 100′ does not have any battle action, asset record, or media asset files that are newly required, that is, they have been previously distributed, then game unit 100′ (corresponding to memory map 1030) does not need to provide a battle round message, except as may be used for synchrony, as described below.

If players are entering commands in real-time during iterations of run battle step 905, such as with controls 104 and 105, then these commands are distributed to all game units as battle actions 1110 and 1130. Battle actions 1110 and 1130 preferably further comprise an iteration count kept throughout battle step 905 are signed by the originating game unit, so as to ensure that battle round messages are not subject to tampering while being transmitted between game units.

Note that if device keys 422′, 427′, and 428′ comprise a symmetric key unknown to other game units, that the assurance of uncompromised battles will be obtained later by server 140, through validation of the logs. However, in an alternative embodiment, if device keys comprised a public key/private key pair, and device ID records 422′, 423′, and 424′ further comprise the device public key portion, then during each iteration of run battle step 905, battle round messages 1100 and 1120 could be signed by their originators and authenticated by the other game unit recipients, in real-time.

Even if all necessary media asset files have already been distributed, and there are no battle actions needed, the exchange of battle messages or other signals is desirable to signal the completion of a round, and so would help to keep the units in sync. For example, if master unit 100 waits until it has both completed its calculations for the current round and received battle messages from the other game units 100′ and 100″ indicating their completion, then game unit 100 will release its battle message indicating its completion, which can be used as a synchronization signal among the units, for example, to update displays 102, 102′, and 102″ together. If the synchronization signal is taken as the receipt of the master's battle message 1100, then an immediate screen update is preferably based on a prior computation and the asset record 524″, media file assets 526″, or battle action record 1110 are used in a following calculation of another frame. This allows multiple devices with slightly varying clocks to maintain synchrony over long intervals.

In FIG. 12, post-battle memory maps 1210, 1230, and 1250 are shown, corresponding to game units 100, 100′ and 100″, following the conclusion of run battle step 905. Each participating game unit has accumulated a summary of the battle results, and produces a corresponding log file 1212, 1212′, 1212″ having a signature to authenticate the log file using corresponding device key copy 426′, 427′, and 428′. The log files 1212, 1212′, 1212″, absent the signature, should be identical. Preferably, the individual game units exchange signatures that are appended to the log files 1212, 1212′, and 1212″ so that each game unit has generated its own copy of the same log, and has digital signatures of that log from all game units 100, 100′, and 100″ participating in the logged events.

In log upload process 1270, game unit 100 (represented in FIG. 12 by post-battle memory map 1210) transfers log record 1212 through server 140 to database 142 where it is stored as log record copy 1272. Since log 1212 and the copy 1272 include signatures by each of game units 100, 100′, and 100″, and the log lists the participating game units by device IDs from device ID record copies 422′, 423′, and 424′, server 140 can use these device IDs to find the associated device keys 426, 427, and 428, whereby server 140 can authenticate each of the signatures on log record copy 1272.

Once log record copy 1272 has been authenticated, any battle results that produce a change to a character or game piece or other record having an association with either device ID 422 or user ID 622, can be effected.

For example, suppose that according to log 1272, during the run battle step 905, character 170, belonging to the user associated with user ID 622 and residing on game unit 100 corresponding to device ID 422 and represented by asset record 524 and asset record copy 524′, acquired a new level. During the upload log process 1270, server 140 will apply the indicated improvement (e.g., gaining a level) by updating asset record 524 to form improved asset record 524″. Manifest record 522 may also be updated to become manifest record 522″. In this manner, an authenticated, fraud-resistant modification to the character belonging to its owner has occurred.

Preferably as part of upload log process 1270, game unit 100 is updated to post-upload memory map 1280 by deleting obsolete log record 1212 and loading copies of updated manifest record 522″ and asset record 524″ as replacement manifest record copy 522″′ and asset record copy 524″′.

In an alternative embodiment, upload log process 1270 can use the log record copy 1272 to perform updates to the affected records associated with all of the device IDs 422, 423, and 424, reported by the log 1272 as having participated.

In another alternative embodiment, the battle results reported in log 1272 can include a capture or conversion of a character or other game piece, such that possession and ownership of that piece is transferred from the manifest of one game unit to another. In this alternative embodiment, battle process 900 can be used to implement commerce, such that in planning step 902, one player offers for example to take a character in trade for a collection of game pieces having in-game monetary value, or credits; while the other player plans the reciprocal trade to yield a character in exchange for those credits. The trade is agreed to in the final iteration of run battle step 905, perhaps with haggling taking place during prior iterations of run battle step 905 as directed through controls 104 and 105. The trade or capture is confirmed during log upload process 1270. Care must be taken to implement policies that do not permit this kind of transaction to result in an exploit of this nature: A first player trades a valuable unit to a second player. The first player then induces a device reset process 720 followed by an asset sync process 820 to fraudulently restore the valuable unit to the first player. The first player may now engage to fraudulently trade the restored valuable unit to a third player. If repeated, a large number of players could be under the impression that they each possess this valuable unit, and the scheme can continue until one of the recipients engages upload log process 1270 so that the first player's use of asset sync process 820 removes the valuable unit from his manifest. The form of such care may be to only engage in such trades with real-time communication with server 140. Alternatively, such transactions can be made safe by imposing rules and latencies such that a trade must be consummated with the upload log process 1270 within 24-hours lest it be nullified, and requiring a 24-hour wait following device reset process 720 before asset sync process 820 can be applied. Still another alternative is to disallowing a game unit from participating in trades for 24-hours following an asset sync process 820 and requiring a second asset sync process 820 after that waiting period. Of these methods, the real-time communication with server 140 produces the least intrusive constraint.

Preferably, to forego the requirement for communication with server 140, a form of trade designated as a ‘loan’ may be used. In such a case, the character or other virtual object (e.g., character 170) held by game unit 100 may be selected for a loan to game unit 100′. If accepted, the corresponding asset record copy 524′ and associated media asset files 525′ and 526′ are transferred to the target game unit 100′ in one or more battle round messages as shown in FIG. 11. In the case of a loan, the transferred object is only temporarily made available to the target game unit 100′. This can give the owner of game unit 100′ the opportunity to play with the loaned object (e.g., character 170), and preferably may use that character in battles, but the loaned character is not subject to becoming a part of the permanent inventory of game unit 100′, that is, the loan is not reflected in database 142. Preferably the loan expires in 24-hours, or some other predetermined period, after which the loaned character is no long accessible on the target game unit 100′. Further, for the duration of the loan, the owning player is preferably unable to make use of the loaned object or character, including being unable to make a second loan of the same character, until the loan expires. However, given that a loan is a transient transaction and not permanent one, the exposure to exploits (such as the one described above), is minimal and may be acceptable.

The preferred embodiment is discussed in the context of a handheld, portable game system, which is able to be clipped together with like game systems, to allow player-owned characters to compete. Alternative embodiments have been discussed that employ laptop computers and game consoles.

The particular implementations described, and the discussions regarding details, and the specifics of the figures included herein, are purely exemplary; these implementations and the examples of them, may be modified, rearranged and/or enhanced without departing from the principles of the present invention. In particular, the computer architectures, data structures, and flowcharts herein are exemplary, and significant alteration can be made without departing from the spirit of the invention.

Particular features of user interface, for web site, PC software, and the game unit, and the capabilities of the databases, will depend on the architecture used to implement a system of the present invention, the operating systems of the servers, personal computers, and game unit CPU selected, and the software code written both for the servers, other computers, and game unit. It is not necessary to describe the details of such programming to permit a person or team of ordinary skill in the art to implement the application, user interface and services suitable for implementing a system within the scope of the present invention. The details of the software design and programming necessary to implement the principles of the present invention are readily understood from the description herein.

Various additional modifications to the embodiments of the invention, specifically illustrated and described herein, will be apparent to those skilled in the art, particularly in light of the teachings of this invention. Further, it will be apparent that the functionality of this invention can be incorporated into and function from within the context of other products, including an e-commerce system. It is intended that these cover all modifications and embodiments that fall within the spirit and scope of the invention. Thus, while preferred embodiments of the present invention have been disclosed, it will be appreciated that it is not limited thereto but may be otherwise embodied within the scope of the following claims.

We claim as our invention:

1. A game system comprising:
a plurality of game units, each game unit comprising a computer having a program and data representative of at least one object, each game unit further comprising a display connected to said computer and a communication interface connected to said computer;
at least a first game unit of said plurality of game units further comprising a control connected to the computer of the first game unit, said control operable by a player during execution of a first portion of the program to affect the play;
said plurality of game units formable into an array in which the plurality of game units are able to intercommunicate with each other game unit through the corresponding communication interfaces, and wherein a tiled display is formed of the displays of said plurality of game units; and,
wherein, during execution of a second portion of the program, a view is displayed on the tiled display when each computer renders a portion of said view corresponding to the display corresponding to the computer.

2. The system of claim 1 wherein said communication interface is wireless.

3. The system of claim 1 wherein said communication interface comprises at least one connector such that in the array at least one connector of each game unit is connected to a connector of at least one other game unit, and at least a first computer of the computers can communicate with each other one of the computers.

4. The system of claim 3 wherein said communication interface comprises a serial peripheral interface.

5. The system of claim 3 wherein the first computer communicates with at least one of the other computers directly;

6. The system of claim 5 wherein the first computer communicates with at least one of the other computers indirectly through at least another one of the other computers with which the first computer communicates.

7. The system of claim 1 wherein a first computer communicates synchronization to at least a second computer through the corresponding communication interfaces.

8. The system of claim 1 wherein said second portion of the program determines which portion of said view corresponds to the display, based at least in part on communication from a different computer.

9. The system of claim 1 wherein a first computer obtains said data representative of at least one object from a second computer through the corresponding communication interfaces.

10. The system of claim 1 wherein said data representative of at least one object is used by the second portion of said program on at least one computer to render the object on the corresponding display.

11. The system of claim 1 wherein said control is further operable during the execution of said second portion of the program to affect the play.

12. A method for playing a game comprising the steps of:
a) providing a plurality of game units each comprising a display and a computer having a program and data representative of an object;
b) executing a first portion of the program wherein a control on a first one of the plurality of game units is operated to affect play;
c) assembling the plurality of game units to form an array, said array having a tiled display comprising the displays of the plurality of game units, and wherein at least a first one of the computers has communication with each other computer;
d) executing a second portion of the program wherein a view including at least a portion of the object is rendered on the tiled display using the data.

13. The method of claim 12 wherein said communication is wireless.

14. The method of claim 12 wherein said assembling step c) further comprises making at least one connection to each game unit to provide the communication.

15. The method of claim 12 wherein the first computer has direct communication with a second one of the computers.

16. The method of claim 15 wherein the first computer has indirect communication with a third one of the computers through at least the second computer.

17. The method of claim 12 wherein a second one of the computers determines to which portion of the view corresponds to the corresponding display, based at least in part on communication from the first computer.

18. The method of claim 12 wherein at least one of the computers obtains the data representative of the object from another one of the computers.

19. The method of claim 12 wherein the data representative of the object is used on at least one of the computers to render the object on the corresponding display.

20. The method of claim 12 wherein in step d) said control is operated to affect play.
